(19) United States
(12) Patent Application Publication
(10) Pub. No.: US 2017/0011332 A1
(43) Pub. Date: Jan. 12, 2017

(54) SYSTEM AND METHOD FOR SCORING AND REWARDING THE VALUE A PARTICIPANT PROVIDES TO OTHERS IN MULTI- OR SINGLE-PARTICIPANT ACTIVITIES

(71) Applicants: Edward Moran, Windham, NY (US); Amit K. Gupta, Cortlandt Manor, NY (US)

(72) Inventors: Edward Moran, Windham, NY (US); Amit K. Gupta, Cortlandt Manor, NY (US)

(21) Appl. No.: 14/797,026

(22) Filed: Jul. 10, 2015

(51) Int. Cl. G06Q 10/06; G06Q 50/00; G06Q 30/02

(52) U.S. Cl. CPC G06Q 10/063118; G06Q 30/0214; G06Q 30/0279; G06Q 50/01

(57) ABSTRACT

Embodiments of the present disclosure provide a method of valuing an individual or group of individual's social contributions. This involves an individual first joining or being selected to join a community. The community may be created by a creator who selects the individuals to the community. The individuals participate in activities and as well as challenges of the community. In exchange for their participation and completion, the individual may receive rewards or points associated with the activities and challenges. The individual develops a score based on their social engagement. This score is a Social Engagement Reward Value (SERV) and represents their social engagement within the community. The rewards provided by the creator are awarded by the creator based on the individual's social engagement i.e. SERV and may come from a contributor. Additionally the community may be associated with a sponsor. The contributor, sponsor, and creator may select or retain individuals to the community or allow their rewards or their association with the community to be contingent upon an appropriate level of social engagement or minimum SERV value of the individuals or the aggregate SERV of the community.

### RELATED APPLICATIONS

This application claims priority under 35 USC §119(e) to, and hereby claims benefit of the filing dates thereof pursuant to 37 CFR §1.78(a)(4) of the following U.S. Provisional Patent Applications:
1. U.S. Provisional Application Ser. No. 62/025,540, filed 17 Jul. 2014, (Entitled: “SYSTEM AND METHOD FOR SCORING AND REWARDING THE VALUE A PARTICIPANT PROVIDES TO OTHERS IN MULTI- OR SINGLE-PARTICIPANT ACTIVITIES”);
   Additionally, the above identified U.S. Provisional Patent Application(s) and their subject matter are expressly incorporated by reference in their entirety and made part of the present U.S. Utility Patent Application for all purposes.

### BACKGROUND OF THE INVENTION

1. Field of the Invention

The present invention relates generally to measuring social engagement, and, in particular, to new scoring mechanism that measures a person's value to others in online and offline tasks (social engagement), which in-turn, is rewarded by sponsors of social activities, and merchants who wish to promote their brands, products or services.

2. Description of the Related Art

Businesses today use incentive technologies to reward desired consumer behavior. Couponing, gift cards, discounts, and special rebate offers are some of the traditional means by which merchants attract customers. More recently, the “daily deals” model has emerged worldwide, where a daily special deal is presented to consumers on a bulk purchase basis. Additionally, airline miles, bank and credit card points and rewards systems build loyalty and brand recognition among consumers. In the last decade, many merchants have begun to use “points,” where the accumulation of points leads to a person earning rewards. For example, by rewarding the gathering of points, health insurance companies have successfully incentivized people to lose weight or to quit smoking. Banks have rewarded points to customers for the frequent use of their bank account, or for conducting debit card transactions.

All existing points-based systems rely on one single mechanism, however; a person does a desired action, and in turn, accumulates points related to that action. For example, if a sponsor sets up a points system for losing weight, the sponsor may reward 10 points for every time a user reports their weight, or 25 points every time a person checks-in using their mobile phone at a natural food store, or 100 points when a person actually loses 10 lbs. of weight.

The points system is cumulative, based on the desired actions performed. When a user has acquired sufficient points to redeem for a reward, she proceeds through a redemption process, whereby the points can be converted into a gift card, gift certificate, special deals, travel, or other reward.

In a highly social media-driven environment, where sharing, collaboration, and teamwork are the desired activities, however, the most useful incentive systems must transition from an individual achievement-based system to a social achievement and reward-based system (SARS).

Other systems, including Klout, PeerIndex, Traacker and the Zhou invention (US 2013/0311484 A1), score participants' social influence differently and for different reasons. These other systems look at individuals' textual and online content-creation activities and measure their influence on other online people. Unlike the present system, these systems don't measure the value of the participants to one another as collaborators, and these existing systems consider solely online activities.

### BRIEF SUMMARY OF THE INVENTION

Embodiments of the present invention are directed to systems and methods that are further described in the following description and claims. Advantages and features of embodiments of the present invention may become apparent from the description, accompanying the drawings and claims.

Embodiments of the present disclosure provide a method of valuing an individual or group of individual's social contributions. This involves an individual first joining or being selected to join a community. The community may be created by: a creator who selects the individuals to the community, or individuals coalescing to form a community. The community may be open or closed for membership. In an open community there may be few or no limitations upon joining the community, while a closed community has requirements and an approval process prior to joining. The individuals participate in activities and challenges of the community. These activities or challenges may be created by a creator. While a community represents a collection of activities or challenges relating to a common interest or topic, a creator may also create a challenge or activity not associated with the specific community wherein the individual may also chose to join the different community associated with these other challenges and activities. In exchange for their participation and completion, the individual may receive rewards or points associated with the activities and challenges. The individual develops a score based on their social engagement. This score is a Social Engagement Reward Value (SERV) and represents their social engagement within the community. The rewards provided by the creator are awarded by the creator to an individual for completion of activities or challenges or based on the individual's social engagement i.e. SERV and may come from a contributor. Reward assignment does not need to be exclusively based on an individual's SERV, but may also be earned for completing an activity or challenge. Additionally the community may be associated with a sponsor. The contributor, sponsor, and creator may select or retain individuals to the community or allow their rewards or their association with the community to be contingent upon an appropriate level of social engagement or minimum SERV value of the individuals or the aggregate SERV of the community.

The SERV value is based on the individual's level of participation, engagement, and completion of various social activities and/or challenges. In addition, rewards to challenges and activities participation may be further differentiated on completion as well as performance wherein an individual may only receive the reward if they have the overall best performance or if their performance exceeds a predetermined level as determined by the creator, sponsor, and/or contributor. The community as a whole may receive a SERV score made by aggregating the SERV scores of the individuals within the community.

The rewards may have a collective economic value (CEV). This CEV may be based on the propagation of the reward between individuals within a community as well as charities or groups. Propagation may include how many times an actual award is transferred among individuals or communities. The CEV may also be based on the assignment of a reward to a charity, group, or individual as well as the redemption of the award. These values may be further enhanced or based upon the donation of the reward to a charity, group, or individual associated with both sides of the donation, the donee and the donor. Additionally the CEV may be in part based on the SERV of the individual redeeming the award or the SERV of the individuals to which the reward has been transferred to as it propagates from initial assignment by the creator until redemption.

The individuals and the reward may be further assigned a Brand Loyalty Value (BLV) wherein a measure is made of the number of times an individual returns for an activity or challenge based on the contributor of the reward. Thus individuals that return for rewards from specific contributors and rewards that promote the participation of individuals for rewards associated with this specific contributor may be measured to produce a measure of BLV.

Accordingly, the above problems and difficulties are obviated by embodiments of the present invention which provide

### BRIEF DESCRIPTION OF THE SEVERAL VIEWS OF THE DRAWINGS

My invention may be more fully understood by a description of certain preferred embodiments in conjunction with the attached drawings in which:

FIG. 1 is a flow diagram that describes the most common method of interaction between an individual and a community whereby the individual socially engages with the community and performs activity(s) or individual challenge(s) in accordance with embodiment(s) of the present disclosure;

FIG. 2 is a flow diagram that describes a second common method of interaction between an individual, a community, and other parties (individuals and charities) whereby the individual socially engages with the community as measured by participating in various activities and challenges and provides the rewards from those activities to other parties in accordance with embodiment(s) of the present disclosure;

FIG. 3 is a flow diagram that describes another method of interaction between an individual, a first community, and additional communities whereby the individual socially engages with the first community and additional communities as measured by participating in various activities and challenges and provides the rewards from those activities to other parties within other communities in accordance with embodiment(s) of the present disclosure;

FIG. 4 is a flow diagram that describes another method of interaction between a first individual, second individual, a first community, and additional communities whereby the individual socially engages with the first community and additional communities as measured by participating in various activities and challenges and provides the rewards from those activities to other parties, individual within community in accordance with embodiment(s) of the present disclosure;

FIG. 5 is a flow diagram that describes another method of interaction between a group of individuals, a first community, wherein at least two of the individuals form a team that joins community whereby team socially engages with the first community and additional potential communities as measured by participating in various activities and challenges and provides the rewards from those activities to other parties, individual and organizations in accordance with embodiment(s) of the present disclosure;

FIG. 6 is a flow diagram that describes communications between individuals and in diverse communities, whereby communication increases the awareness and social engagement and awareness of various activities and challenges in accordance with embodiment(s) of the present disclosure;

FIG. 7 is a flow diagram that describes another method of interaction between an individual, a new community, and additional individuals whereby the individual socially engages with the new community as measured by participating in various activities and challenges and provides the rewards from those activities in accordance with embodiment(s) of the present disclosure;

FIG. 8 is a flow diagram that describes another method of interaction between an individual, a community, and a merchant whereby the merchant creates community to engage individuals socially as measured by participating in various activities and challenges and provides the rewards from those activities in accordance with embodiment(s) of the present disclosure;

FIG. 9 is a flow diagram that describes another method of interaction between an individual, a community, and a merchant whereby the individual with rewards from merchant creates community to engage individuals socially as measured by participating in various activities and challenges and provides the rewards from those activities in accordance with embodiment(s) of the present disclosure;

FIG. 10 is a flow diagram that describes another method of interaction or lack thereof between an individual, a community, and other individuals and charitable organizations 1006 whereby the individual's SERV score may decrease or otherwise be negatively impacted by not participating in various activities and challenges in accordance with embodiment(s) of the present disclosure;

FIG. 11 is a flow diagram that describes another method of interaction between an individual, a community, and other individuals and charitable organizations whereby the individual's SERV score may increase by participating in various activities and challenges 1110 in accordance with embodiment(s) of the present disclosure;

FIG. 12 is a flow diagram that describes another method of interaction between an individual, a community, and other individuals and charitable organizations whereby the individual's SERV score may increase by participating in various activities and challenges in accordance with embodiment(s) of the present disclosure;

FIG. 13 is a flow diagram that describes another method of interaction between an individual, a community, a team of individuals whereby the individual's SERV score may increase by participating in various activities and challenges in accordance with embodiment(s) of the present disclosure;

FIG. 14 is a flow diagram that describes another method of interaction between an individual, individuals and a merchant whereby the rewards provided by the merchant are assigned value based on their propagation between users in accordance with embodiment(s) of the present disclosure.

In the drawings, similar elements will be similarly numbered whenever possible. However, this practice is simply for convenience of reference and to avoid unnecessary proliferation of numbers, and is not intended to imply or suggest that the present disclosure requires identity in either function or structure in the several embodiments.

### DETAILED DESCRIPTION OF THE INVENTION

Preferred embodiments of the present invention are illustrated in the FIGs., like numerals being used to refer to like and corresponding parts of the various drawings.

There are systems today that monetize people's social interactions through the use of advertising, and there are also systems that reward individuals for demonstrating desired behaviors, where the reward comes from a merchant, employer, or another entity, which has something to gain from the individual performing the desired behavior. However, in the latter case, the individual's own performance, behavior, and achievement is measured for the reward, without any consideration of how engaged that person is with others in the community, and how valuable that person is to others in the community. Social media systems have been successful because individuals openly interact with each other, in order to share, communicate, help or give to others, promote a cause they believe in, and for many other such social reasons. A system that is able to score the value of these social contributions, and based on the score, reward individuals for their social engagement and value that they provide to other members of the community, provides a meaningful way for merchants to create product or business ambassadors, to increase purposeful activity within communities, and to measure the value a group of people might provide to others. The present disclosure describes a social achievement and reward system (SARS), along with a social score (Social Engagement Reward Value (SERV)), associated with each individual, much in the same way as a financial credit score is associated today. Furthermore, from a merchant's perspective, the invention in SARS defines a new way for a merchant to gain further insights about their special offers, coupons, products, services or merchandise based on the Collective Economic Value (CEV) and the Brand Loyalty Value (BLV) of the rewards they offer in the system to engage the users, who then socially disseminate these rewards and brands.

Rewards may be in the form of but not limited to: points that are accumulated and may be applied for specific credits, services, products, or activities; or specific credits, services, products, or activities themselves. One unique aspect of this disclosure is the ability to provide peer to peer off line rewards as part of a challenge. The rewards may have requirements from the creator, sponsor, or contributor to provide proof of completion of the activity or challenge. In the case of a peer to peer reward completion is not automatically tracked by the platform. Similarly, should a peer reward not be provided as earned, the reward providee may be able to provide feedback to the platform on the reward provider.

Throughout this description, the terms assert and negate may be used when referring to the rendering of a signal, signal flag, status bit, or similar apparatus into its logically true or logically false state, respectively, and the term toggle to indicate the logical inversion of a signal from one logical state to the other. Alternatively, reference may be made to the mutually exclusive Boolean states as logic_0 and logic_1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

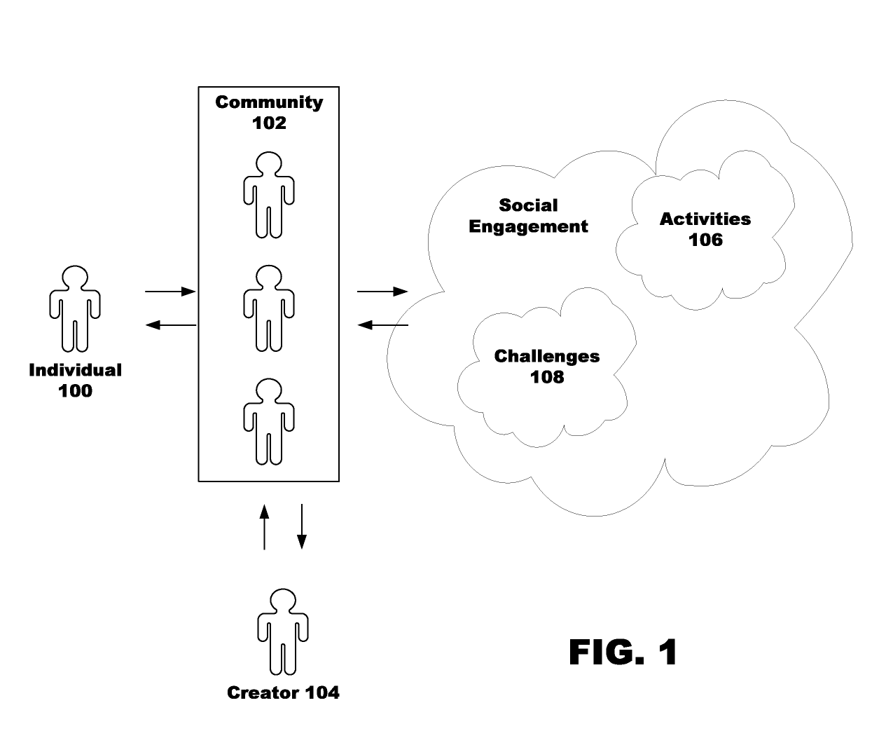

FIG. 1 is a flow diagram that describes the most common method of interaction between an individual 100 and a community 102 whereby the individual socially engages with the community and performs activity(s) 103 or individual challenge(s) 108 in accordance with embodiment(s) of the present disclosure. In a common scenario within the SARS platform, the individual 100 searches for a community (the community being previously created by creator 104), activity or challenge. Individual 100 joins or is selected to join the community 102 by creator 104, and becomes socially engaged with the community 102 as measured by participation and completion of one or more activities 106 and challenges 108.

The community may be created by: a creator who selects the individuals to the community, or individuals coalescing to form a community. The community may be open or closed for membership and may or may not require an administrator. In an open community there may be few or no limitations upon joining the community, while a closed community has requirements and an approval process prior to joining. The individuals participate in activities and challenges of the community. These activities or challenges may be created by a creator. While a community represents a collection of activities or challenges relating to a common interest or topic, a creator may also create a challenge or activity not associated with the specific community wherein the individual may also chose to join the different community associated with these other challenges and activities. Creators may be individual(s), organization, group or team of individuals.

The individual may receive Social Engagement Reward Value (SERV) credit for the individual's social engagement with the first community; the SERV represents the individual's level of participation, engagement and completion of the activities and/or challenges. Multiple levels or SERV credit may be available depending on the individuals' level of participation, engagement and completion of the activities and/or challenges. The SERV score of individual 100 increases due to participation in a social community 102.\

The SERV score may vary with an individual's level of participation and engagement with social activities that benefit another user, business, merchant, sponsor, community, team of people, or society as a whole. A partial list of social actions is provided in Table 1.

TABLE 1
Social Actions include but are not limited to:

| 1. | Creating or participating in private or non-private challenges | |
|---|---|---|
| | and/or communities and activities | |
| 2. | Sharing challenges or activities on social media | |
| 3. | Actively creating and promoting challenges and activities | |
| | within the system | |
| 4. | Participating frequently in challenges and communities | |
| | with activities | |
| 5. | Creating teams and creating teams of certain size | |
| 6. | Adding proof for completing a challenge or activity | |
| 7. | Adding friends or inviting friends to the system to perform | |
| | a challenge or activity | |
| 8. | Number of challenges or activities completed in a certain | |
| | period of time | |
| 9. | Amount of time taken by user to complete a challenge or | |
| | activity after joining | |
| 10. | Participating frequently in charity challenges | |
| 11. | Frequently donating rewards to a charity or to another | |
| | user | |
| 12. | Earning rewards as a team | |
| 13. | Earning rewards and transferring or donating reward to another | |
| | user | |
| 14. | Earning reward and transferring or donating reward to a charity | |
| 15. | Reassigning an earned reward to another challenge or | |
| | community with activities | |
| 16. | For creating communities, activities or challenges of certain | |
| | category or industry (for example, health & fitness, weight | |
| | loss etc. that promote social well-being) | |
| 17. | Earning a reward as a team owner and transferring that reward to | |
| | another user within that team | |
| 18. | Earning a reward as a team owner and transferring that reward to | |
| | a charity or person in need. | |
| 19. | For being communicative with others users in a community, | |
| | or challenge | |
| 20. | For helping other users complete the activity or challenge | |
| 21. | For performing a social action that helps a person in need or a | |
| | charitable organization | |
| 22. | For performing a social action that helps another user | |
| 23. | For building a team and performing social activities together | |
| 24. | For building communities with activities and challenges for | |
| | other users to perform | |
| 25. | For promoting or advertising communities with activities and | |
| | challenges for other users to perform within the system or | |
| | anywhere in the Internet | |
| 26. | For building communities with activities and challenges for other | |
| | users to perform, where the user creating such communities, | |
| | activities, and challenges, provides incentives | |
| | a. | The user creating such communities, activities and challenges |
| | | provides their own incentives by purchasing them on the system |
| | b. | The user creating such communities, activities, and challenges |
| | | earns the incentives by participating in other user's or |
| | | merchant's communities, activities, and challenges, then |
| | | assigns the earned incentives to his or her own communities, |
| | | activities or challenges |

| | |
|---|---|
| 27. | For a user communicating with other users |
| 28. | For a user communicating about a community, activity, or challenge |
| | with other users performing those activities and challenges in those |
| | communities |
| 29. | For a user persevering, and seeing activities and challenges |
| | through to completion |
| 30. | For a user to compete and win an activity in a community |
| 31. | For a user to compete and win a challenge |
| 32. | For a user to create a story page of all their social and community |
| | involvement |
| 33. | For a user to promote a special cause through their story page |
| 34. | For a user to engage others through their story page, to participate |
| | in a cause |
| 35. | For use by a user, their associated rewards card to redeem rewards |
| 36. | For use by a user, their associated rewards card to gift a reward |
| | to a charity |
| 37. | For determining negative scores, when users are not performing |
| | certain actions such as joining a community, activity or challenge |
| | or joining but not starting them, or not completing them, or not |
| | inviting others to help |

Challenges 108 may appear to individuals and potential users as links from various user interfaces such as the internet. For example a challenge may appear as a banner, widget or ad within a web page. This allows challenges to advertise and recruit individuals to the challenges from the creator.

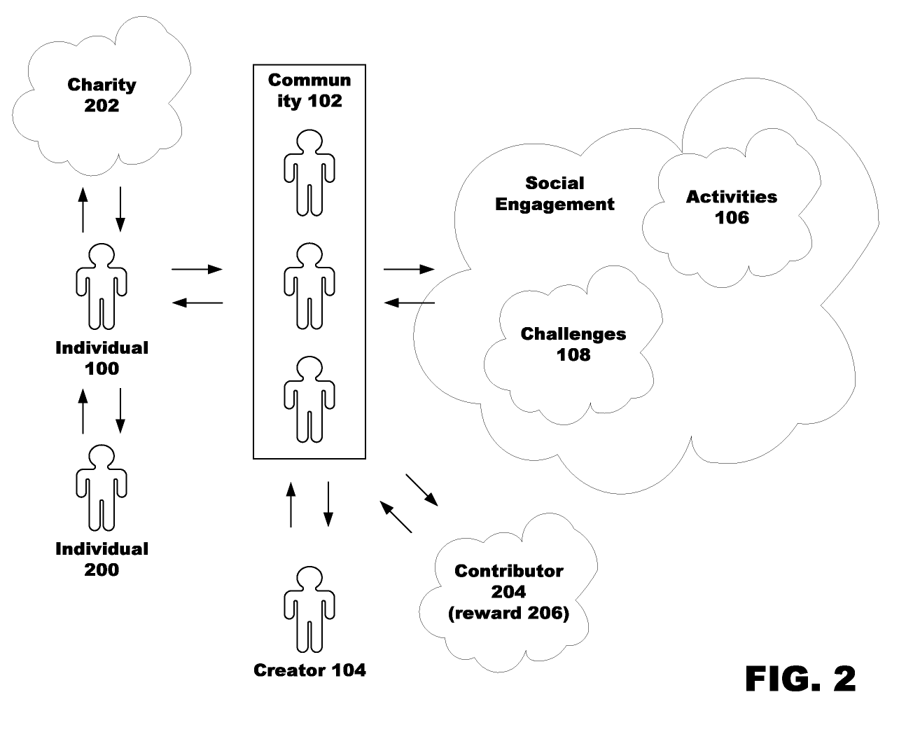

FIG. 2 is a flow diagram that describes a second common method of interaction between an individual 100, a community 102, and other parties (individuals 200 and charities 202) whereby the individual socially engages with the community as measured by participating in various activities 106 and challenges 108 and provides the rewards from those activities to other parties in accordance with embodiment(s) of the present disclosure.

In this scenario within the SARS platform, the individual 100 searches for a community (the community being previously created by creator 104), activity or challenge. Individual 100 joins or is selected to join the community 102 by creator 104, and becomes socially engaged with the community 102 as measured by participation and completion of one or more activities 106 and challenges 108. As in FIG. 1, the individual may receive SERV credit for the individual's social engagement with the first community; the SERV represents the individual's level of participation, engagement and completion of the activities and/or challenges. In addition to this SERV credit, the individual may receive rewards based the individuals level of participation, engagement and completion of the activities 106 and/or challenges 108. The rewards may be provided by a contributor to the community and are awarded by the creator 104. The contributor 204 may place limitations on which creators 104, community 102 and individuals 100 can receive their awards. For example, a contributor 104 may set a minimum SERV score for the creator 104, community 102, and individual 100 for their various levels of awards. After the individual 100 receives a reward 206, the individual 100 may decide to donate the reward to a person in need (individual 200), who is registered in the SARS platform to receive charitable donations. This registration may be based on their unusual financial or other situational circumstances. Individual 100 may also decide to donate the reward or points to an official charitable organization 202 registered in the SARS platform. The individual's SERV score may increase for participating in a community, activity, or challenge and earning a reward or points, and further increase for donating such reward or points to another individual in need or charitable organization.

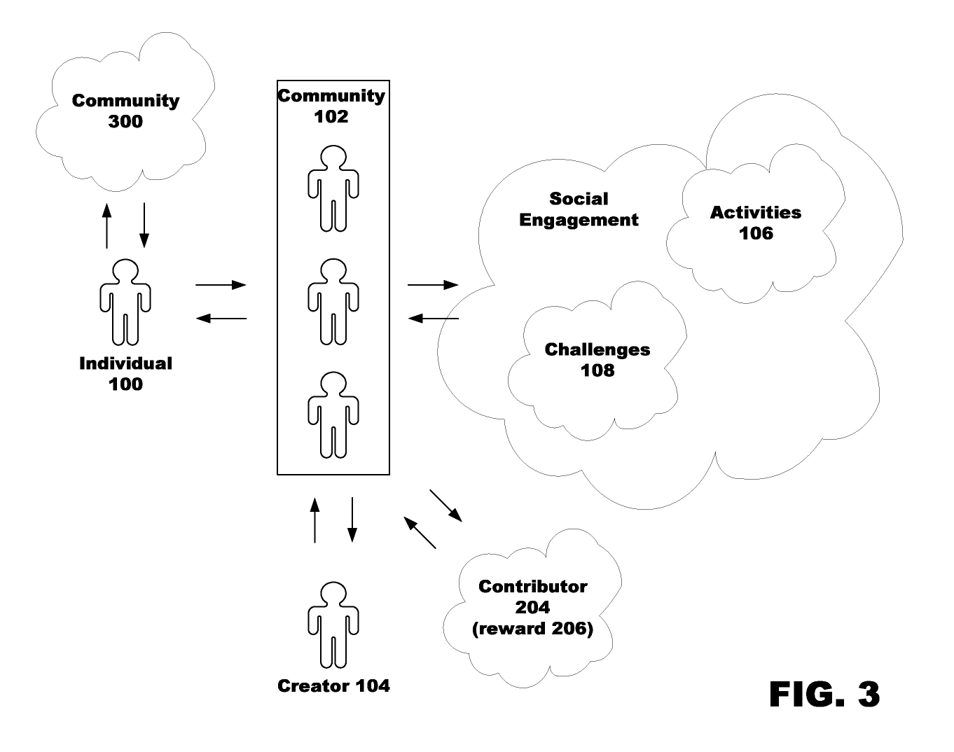

FIG. 3 is a flow diagram that describes another method of interaction between an individual 100, a first community 102, and additional communities 300 whereby the individual socially engages with the first community and additional communities as measured by participating in various activities 106 and challenges 108 and provides the rewards from those activities to other parties within other communities in accordance with embodiment(s) of the present disclosure.

In this scenario within the SARS platform, the individual 100 searches for a community (the community being previously created by creator 104), activity or challenge. Individual 100 joins or is selected to join the community 102 by creator 104, and becomes socially engaged with the community 102 as measured by participation and completion of one or more activities 106 and challenges 108. As in FIG. 1, the individual may receive SERV credit for the individual's social engagement with the first community; the SERV represents the individual's level of participation, engagement and completion of the activities and/or challenges. In addition to this SERV credit, the individual may receive rewards based the individuals level of participation, engagement and completion of the activities 106 and/or challenges 108. The rewards may be provided by a contributor to the community and are awarded by the creator 104. The contributor 204 may place limitations on which creators 104, community 102 and individuals 100 can receive their awards. For example, a contributor 104 may set a minimum SERV score for the creator 104, community 102, and individual 100 for their various levels of awards. After the individual 100 receives a reward 206, the individual 100 may decide to award the reward to an individual in their community 300 following the completion of community activities and challenges within community 300. This award may still be subject to the guidance and limitations of contributor 204. The individual 100's SERV score may increase for creating a new community 300 with new individual participants, activities or challenges and further increase for propagating rewards 206 to other individuals or organizations.

Individual 100 creates his own community 300 with activities and challenges, to promote their own business or special cause. The individual 100 can assign his earned points or rewards to one or more activities or challenges in the newly created community 300. Individual 100's SERV score increases for participating in a community, activity, or challenge and earning a reward or points, and further increases for donating such reward or points to another user or charitable organization.

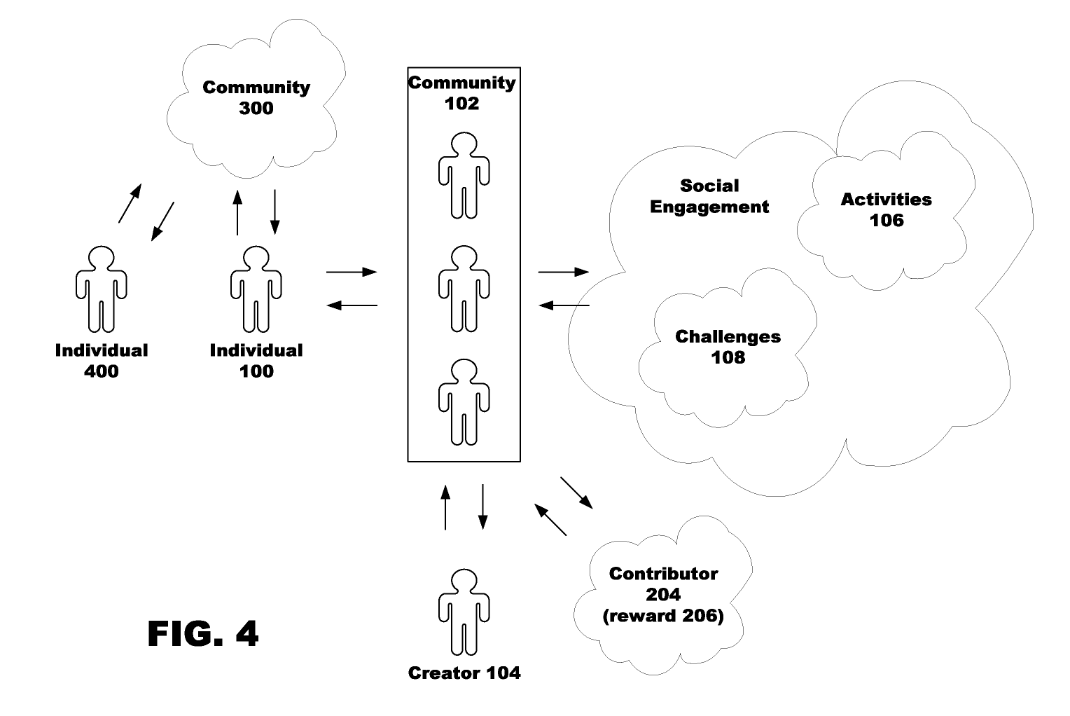

FIG. 4 is a flow diagram that describes another method of interaction between a first individual 100, second individual 400, a first community 102, and additional communities 300 whereby the individual 100 socially engages with the first community and additional communities as measured by participating in various activities 106 and challenges 108 and provides the rewards from those activities to other parties, individual 400 within community 300 in accordance with embodiment(s) of the present disclosure.

In this scenario within the SARS platform, the individual 100 searches for a community (the community being previously created by creator 104), activity or challenge. Individual 100 joins or is selected to join the community 102 by creator 104, and becomes socially engaged with the community 102 as measured by participation and completion of one or more activities 106 and challenges 108. As in FIG. 1, the individual 100 may receive SERV credit for the individual's social engagement with the first community; the SERV represents the individual's level of participation, engagement and completion of the activities and/or challenges. In addition to this SERV credit, the individual may receive rewards based the individuals level of participation, engagement and completion of the activities 106 and/or challenges 108. The rewards may be provided by a contributor to the community and are awarded by the creator 104. The contributor 204 may place limitations on which creators 104, community 102 and individuals 100 can receive their awards. For example, a contributor 104 may set a minimum SERV score for the creator 104, community 102, and individual 100 for their various levels of awards. After the individual 100 receives a reward 206, the individual 100 may decide to award the reward to an individual in their community 300 following the completion of community activities and challenges within community 300. This award may still be subject to the guidance and limitations of contributor 204. Individual 400 may receive SERV credit for the individual 400's social engagement with the community 300; the SERV represents the individual 400's level of participation, engagement and completion of the activities and/or challenges. In addition to this SERV credit, the individual 400 may receive rewards based the individual's level of participation, engagement and completion of the activities and/or challenges. The individual 400's SERV score may increase for further propagating rewards 206 to other individuals or organizations.

Individual 100 creates community 300 with activities and challenges, to promote their own business or special cause. Community 300 may also have its own contributors and sponsors that provide rewards that individual 100 can assign to one or more activities or challenges in the newly created community 300. Individual 400's SERV score increases for participating in a community, activity, or challenge and earning a reward or points, and further increases for donating such reward or points to another user or charitable organization.

The SERV score for individual 100 increases because the individual successfully engaged another, individual 400, in a social activity. The SERV score for individual 400 increases because he chose to participate in a social community, activity or challenge.

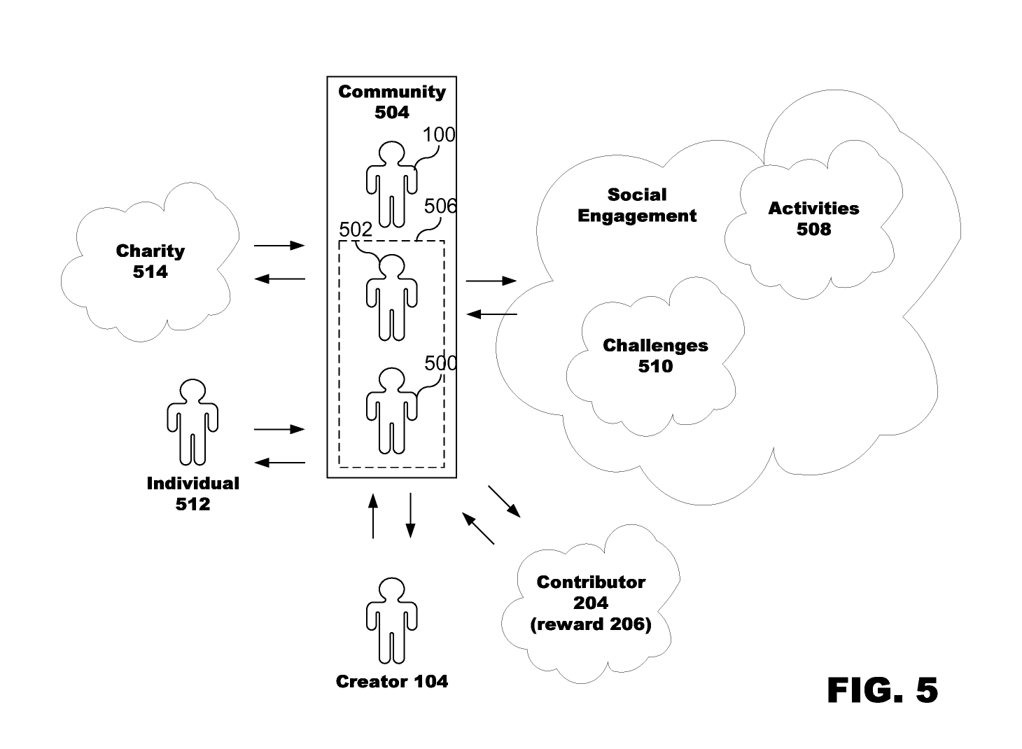

FIG. 5 is a flow diagram that describes another method of interaction between a group of individuals 100, 500 and 502, a first community 504, wherein at least two of the individuals form a team 506 that joins community 504 whereby team 506 socially engages with the first community and additional potential communities as measured by participating in various activities 508 and challenges 510 and provides the rewards from those activities to other parties, individual 512 and organizations 514 in accordance with embodiment(s) of the present disclosure.

In this scenario within the SARS platform, the individuals 100, 500 and 502 search for a community (the community being previously created by creator 104), activity or challenge. At least two of the individuals form a team 506 that is selected to join the community 504 by creator 104, and becomes socially engaged with the community 504 as measured by participation and completion of one or more activities 508 and challenges 510. As in FIG. 1, the individuals may receive SERV credit for the individual's social engagement with the community; the SERV represents the individual's level of participation, engagement and completion of the activities and/or challenges. In addition to this SERV credit, the individuals/team may receive rewards based the individuals level of participation, engagement and completion of the activities 508 and/or challenges 510. The rewards may be provided by a contributor to the community and are awarded by the creator 104. The contributor 204 may place limitations on which creators 104, community 504 and individuals/teams can receive their awards. For example, a contributor 204 may set a minimum SERV score for the creator 104, community 504, and individuals for their various levels of awards/rewards 206. After the individuals/team receives reward 206, the team may decide to donate the reward to a charity 514 or person in need (individual 512), who is registered in the SARS platform to receive charitable donations. This registration may be based on their unusual financial or other situational circumstances. Individual 100 may also decide to donate the reward or points to an official charitable organization 514 registered in the SARS platform. The individual's SERV score may increase for participating in a community, activity, or challenge and earning a reward or points, and further increase for donating such reward or points to another individual in need or charitable organization.

The SERV score for individuals of team 506 increases because the individual successfully engaged a team to successfully participate in a social community, activity or challenge and donate the rewards.

The team 506 joined a community to perform activities or challenges. Once the team completed one or more activities or challenges, the team is rewarded. Both team members' SERV score increases. The team organizer determines what can be done with the reward or points earned. The team members may split the reward or points, or they may donate to a person in need in the SARS platform, or donate it to an official charitable organization. The SERV score for all team members increases further.

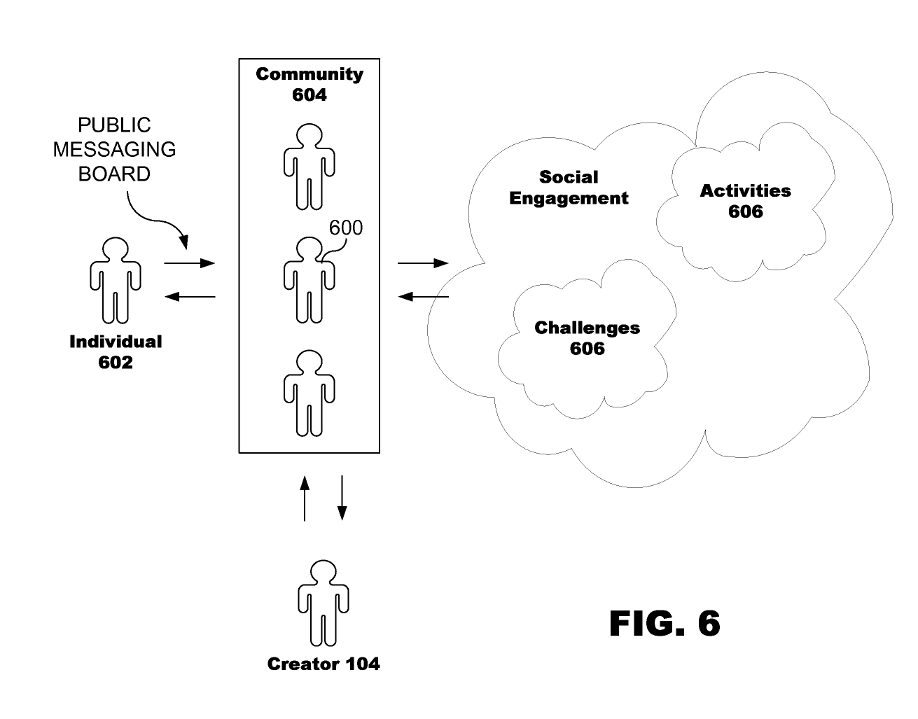

FIG. 6 is a flow diagram that describes communications between individuals 600 and 602 in diverse communities, whereby communication increases the awareness and social engagement and awareness of various activities and challenges in accordance with embodiment(s) of the present disclosure. Individual 600 joins community 604, and accepts to participate in activities and challenges 606. As the individual 600 is performing the activities and challenges 606, individual 600 actively communicates with individual 602 about the activity or with the moderator of the community within the SARS platform. The SERV score for individual 600 increases as a result of the communicating. Individual 600 also has a social connection with individual 602, who is part of a community that they both have in common. Individual 600 communicates with individual 602 on a public messaging board about the community, activity or challenge within SARS platform. The SERV score for individual 600 increases because individual 600 reached out to another user from within a community, to build a new social relationship. This public messaging board may also serve as a feedback mechanism for peer to peer aspects of the platform. This allows tracking of peer to peer rewards where completion is not automatically tracked by the platform. Similarly, should a peer reward not be provided as earned, the reward providee may be able to provide feedback to the platform on the reward provider. This also allows the community to rate a peer provided reward.

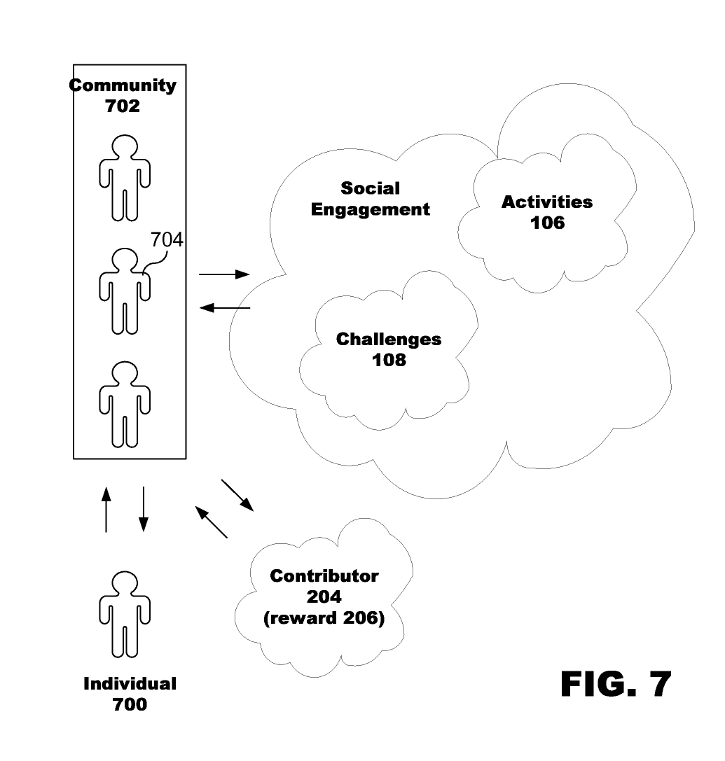

FIG. 7 is a flow diagram that describes another method of interaction between an individual 700, a new community 702, and additional individuals 704 whereby the individual 704 socially engages with the new community 702 as measured by participating in various activities 706 and challenges 708 and provides the rewards from those activities in accordance with embodiment(s) of the present disclosure.

In this scenario within the SARS platform, the individual 700 creates new community 702. Individual 700 selects individual 704 to join the community 702, and individual 704 becomes socially engaged with the community 702 as measured by participation and completion of one or more activities 706 and challenges 708. As in FIG. 1, the individuals 700 and 704 may receive SERV credit for the individual's social engagement with the community; the SERV represents the individual's level of participation, engagement and completion of the activities and/or challenges. In addition to this SERV credit, the individual may receive rewards based the individuals level of participation, engagement and completion of the activities 706 and/or challenges 708.

The rewards may be provided by a contributor to the community and are awarded by the individual 700. Individual 700 purchases points or rewards within the SARS platform. Individual 700 assigns the points or rewards to various activities or challenges. Individual 700's SERV increases as a result of purchasing new points or rewards, and then again for creating a new community, activity, or challenge and assigning points or rewards to them. Individual 702 joins the community to perform one or more activities or challenges and earns a reward or points. Individual 700's SERV increases more because individual 700 successfully engaged and completed an activity or challenge sponsored by individual 700. Individual 702's SERV increases because the individual joined a community to do one or more activities or challenges and completed successfully.

The contributor 204 may place limitations on which individual 700, individual 704 and community 702 can receive their awards. For example, a contributor 204 may set a minimum SERV score for their various levels of awards. After the individual 702 receives a reward 206, the individual 702 may decide to award the reward to an individual or organization as previously discussed. This award may still be subject to the guidance and limitations of contributor 204. The individual 700's SERV score may increase for creating a new community 702 with new individual participants, activities or challenges and further increase for propagating rewards 206 to other individuals or organizations.

Individual 700 creates new community 702 with activities and challenges, to promote their own business or special cause. The individual 700 can assign his purchased or earned points or rewards to one or more activities or challenges in the newly created community. Individual 700 and 702's SERV score increases for participating in a community, activity, or challenge and earning a reward or points, and may further increase for donating such reward or points to another user or charitable organization.

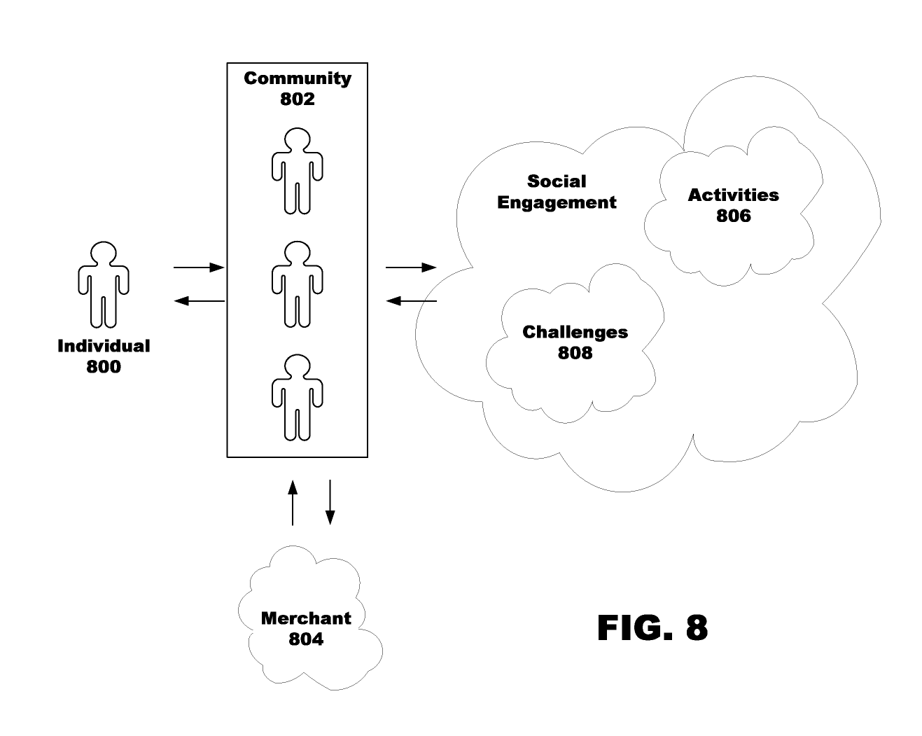

FIG. 8 is a flow diagram that describes another method of interaction between an individual 800, a community 802, and a merchant 804 whereby the merchant 804 creates community 802 to engage individuals 800 socially as measured by participating in various activities 806 and challenges 808 and provides the rewards from those activities in accordance with embodiment(s) of the present disclosure.

A merchant creates a community, with activities and challenges to promote their product or business. An individual 800 engages with community, and performs at least one activity 806 or challenge 808. Individual 800 receives rewards for completing at least one activity or challenge in the merchant's community 802. Individual 800's SERV score increases. Individual 800 repeatedly completes the merchant's activities and challenges as a loyal user, therefore qualifying for special status with the merchant to receive additional privileges. A Brand Loyalty Value (BLV) may be assigned to the individual 800 by merchant 804 as a result. All this activity causes individual 800's SERV score to increase further.

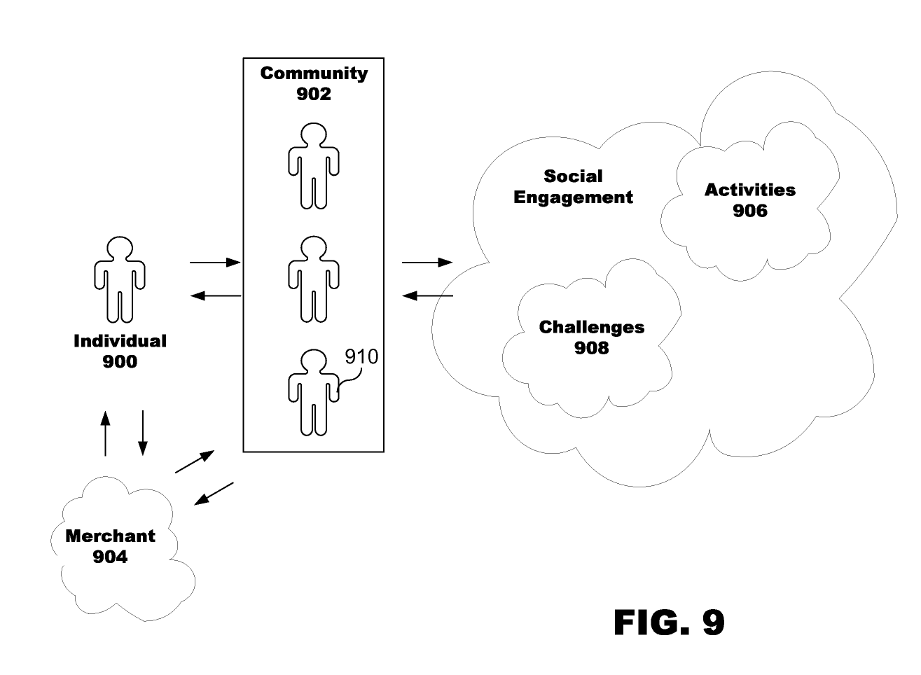

FIG. 9 is a flow diagram that describes another method of interaction between an individual 900, a community 902, and a merchant 904 whereby the individual 900 with rewards from merchant 904 creates community 902 to engage individuals 910 socially as measured by participating in various activities 906 and challenges 908 and provides the rewards from those activities in accordance with embodiment(s) of the present disclosure.

Merchant 904 makes available special offers, coupons, or deals in the system to all individuals 900. Individual 900 creates a community 902 with one or more activities 906 or challenges 908, where at least one or more activities or challenges are assigned the merchant's special offer, coupon, or deal. Individual 900's SERV score increases. Individual 910 participates in, and completes one or more activities 906 or challenges 908 created by individual 900. Individual 910 is rewarded the merchant's special offer, coupon, or deal from individual 900. Individual 910's SERV score increases. Individual 900 repeatedly engages other individuals in their community 902 to perform activities and challenges, disseminating the merchant's special offers, coupons, or deals, thereby receiving special status or privilege with the merchant. Individual 900's SERV score continuously increases for each instance of engaging another individual. Individual 910 repeatedly engages in communities, and completes activities and challenges, which repeatedly earn the merchant's special offer, coupon, or deal, thereby earning him or her special status or privilege with the merchant. Individual 910's SERV score increases repeatedly for each time the individual engages.

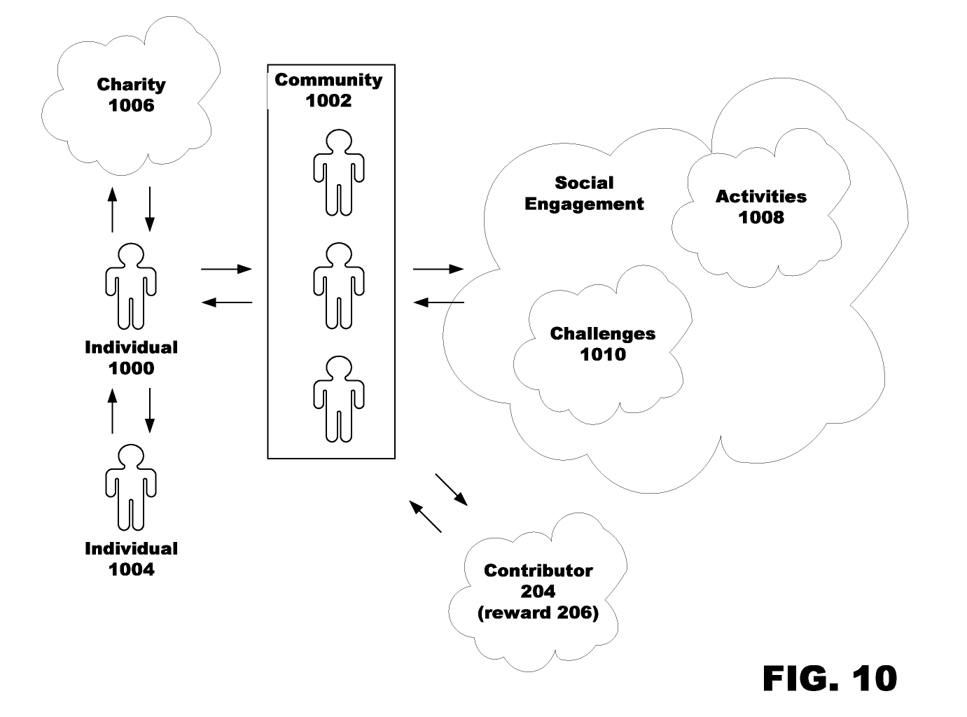

FIG. 10 is a flow diagram that describes another method of interaction or lack thereof between an individual 1000, a community 1002, and other individuals 1004 and charitable organizations 1006 whereby the individual 1000's SERV score may decrease or otherwise be negatively impacted by not participating in various activities 1008 and challenges 1010 in accordance with embodiment(s) of the present disclosure.

An individual 1000 that is a member of the SARS platform, and does not join any community, activity, or challenge, or joins a community 1002, activity 1008, or challenge 1010 but does not actually start doing the activity or challenge may see their SERV score negatively impacted. The SERV score of individual 1000 can decrease. If individual 1000 starts an activity or challenge, and does not complete the activity or challenge, the SERV score of individual 1000 can decrease. If individual 1000 does not invite anyone to join an activity or challenge to do together, their SERV score can decrease. If an individual 1000 is part of a team, and the individual does not add a new team member over a certain period of time to expand the team, their SERV score can decrease. If individual 1000 completes an activity or challenge, earns the reward, and does not give the reward to individual 1004 or a charitable organization 1006, their SERV score may decrease.

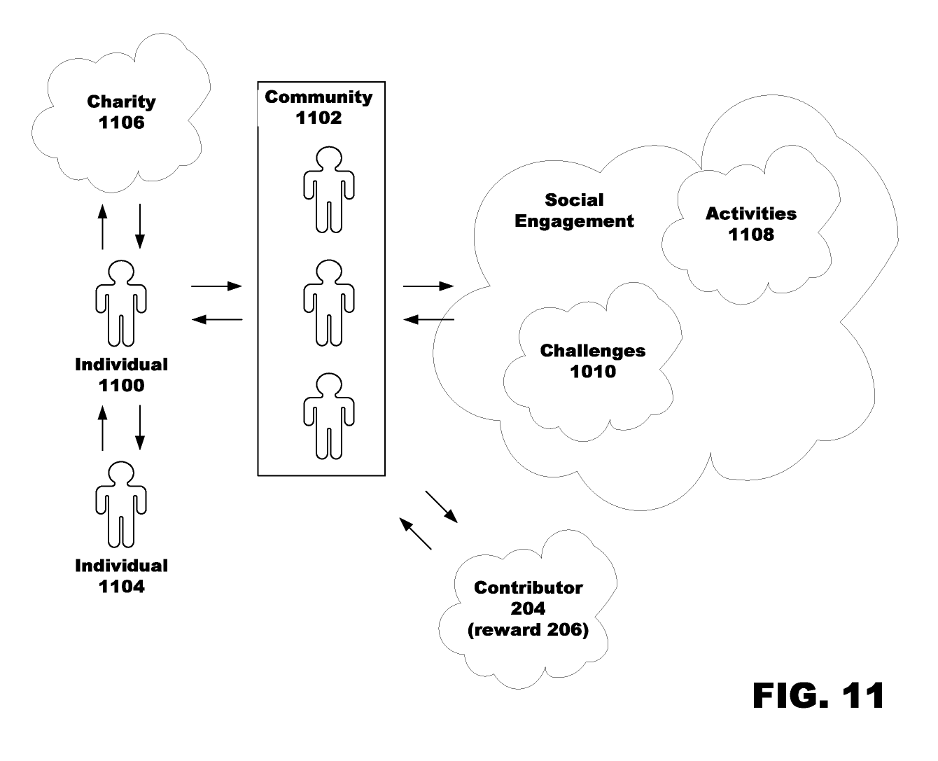

FIG. 11 is a flow diagram that describes another method of interaction between an individual 1100, a community 1102, and other individuals 1104 and charitable organizations 1106 whereby the individual 1100's SERV score may increase by participating in various activities 1108 and challenges 1110 in accordance with embodiment(s) of the present disclosure.

An individual 1100 that is a member of the SARS platform, and joins any community, activity, or challenge, or joins a community 1102, activity 1108, or challenge 1110 and begins the activity or challenge may see their SERV score positively impacted. Individual 1100 receives a reward 206. The SERV score of Individual 1100 increases for completing at least one or more activities or challenges. Individual 1100 becomes qualified for another reward within the SARS platform, such reward either being offered by a merchant, community sponsor, or any other third party for Individual 1100 achieving a specific SERV score that was pre-defined to earn a reward 206.

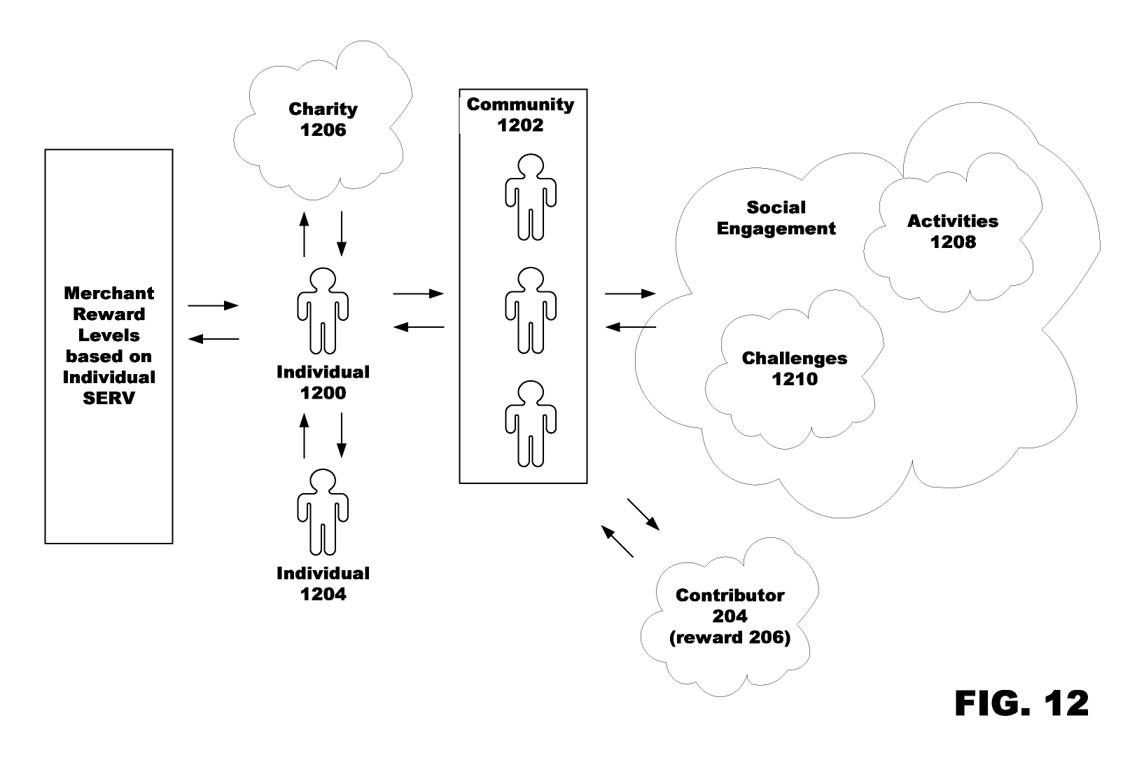

FIG. 12 is a flow diagram that describes another method of interaction between an individual 1200, a community 1202, and other individuals 1204 and charitable organizations 1206 whereby the individual 1200's SERV score may increase by participating in various activities 1208 and challenges 1210 in accordance with embodiment(s) of the present disclosure.

An individual 1200 that is a member of the SARS platform, and joins any community, activity, or challenge, or joins a community 1202, activity 1208, or challenge 1210 and begins the activity or challenge may see their SERV score and available merchant rewards positively impacted. The SERV score of Individual 1200 increases for completing at least one or more activities or challenges (14). Individual 1200 earns a specific status or privilege with a merchant in the SARS platform that defines a specific reward level (A, B, C). The reward levels make Individual 1200 eligible or pre-qualified for use of certain high-level rewards the merchant offers to only those users, who are highly engaged in the system as determined by the SERV score. Individual 1200 is not earning these rewards. Individual 1200, however, can use the available rewards at the specific reward level to assign them to their communities, activities, or challenges, to engage a greater number of people in the system, therefore making their community, activity, or challenge more privileged by having a higher end third-party or merchant reward associated with it.

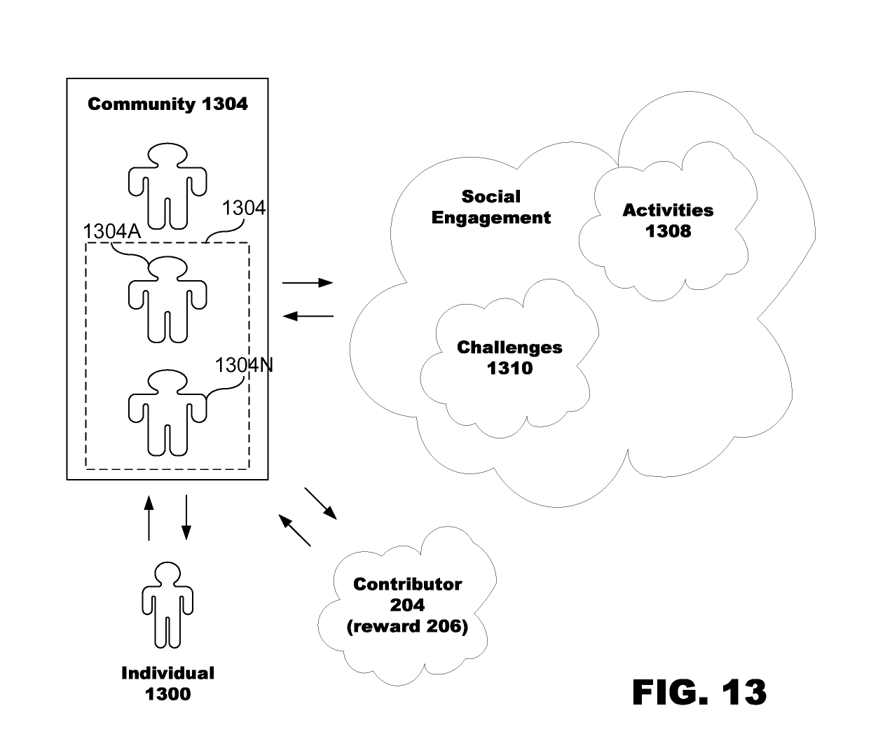

FIG. 13 is a flow diagram that describes another method of interaction between an individual 1300, a community 1302, a team of individuals 1304 whereby the individual 1300 and 1304's SERV score may increase by participating in various activities 1308 and challenges 1310 in accordance with embodiment(s) of the present disclosure. Team 1304 of individuals 1304A-N joins community 1302 to perform activities and challenges in community 1302. When team 1304 completes at least one or more activities in the community 1302, the SERV score of all team members increases. Team 1304 selects the most valuable team member (1304A), who helped or participated the most causing the SERV score of individual 1304A to increase even more. When team 1304 comments positively towards individual 1300's community 1302, activity 1308, or challenge 1310, the SERV score of individual 1300 increases not only for engaging participants of a team who completed at least one or more activities, but for receiving a positive rating or review from the completing member or team.

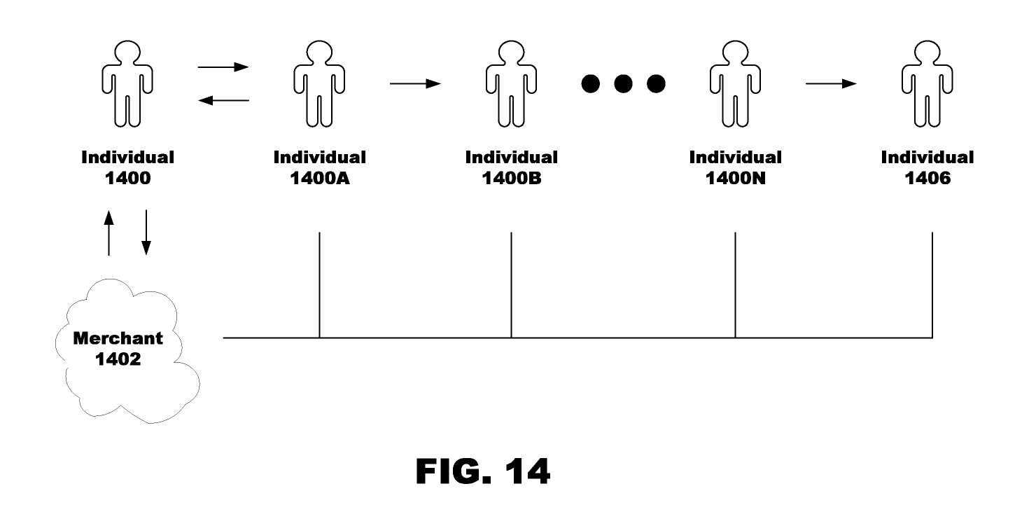

FIG. 14 is a flow diagram that describes another method of interaction between an individual 1400, individuals 1404A-N and a merchant 1402 whereby the rewards provided by the merchant are assigned value based on their propagation between users in accordance with embodiment(s) of the present disclosure.

Merchant 1402 offers at least 1 or more rewards in the SARS platform, in the form or special offers, coupons, deals, products, services, trips, or merchandise, for individuals 1400 to assign to their communities, activities or challenges. The Economic Value of this reward is equal to the market price of the product, service, merchandise, deal, offer or coupon value. The reward is assigned by individual 1400 to their communities, activities, or challenges, and another individual 1404A completes one or more of these activities or challenges, thereby, earning Merchant 1402's reward. If individual 1404A redeems the reward and keeps it for him or herself, after earning it, the Redemption Economic Value (REV) of that reward is determined by taking the actual value of the reward multiplying it with number of times a reward is earned and redeemed in the first pass times factor of 1 (one). If individual 1404A reassigns the earned reward to their own community, activity or challenge, and another individual 1404B earns the reward, and that user assigns to their community, activity, or challenge, until yet another individual 1400N earns the reward, and the cycle continues, then the Accumulative Economic Value (AEV) of that reward is calculated as the actual value of the reward multiplied by average number of times a reward is earned, reassigned to another community, activity, or challenge, and re-earned until it's final redemption multiplied by a factor 3 (three). If individual 1404A earns Merchant 1400's reward, and instead of redeeming for self, donates to individual 1406, then the Servitude Economic Value (SEV) of the reward is calculated as actual value of the reward multiplied by number of users who earned the reward and donated the reward to someone else in the first pass multiplied by a factor of 2 (two). Therefore, the additional value-add that the SARS system is providing to a merchant, is the knowledge of the Collective Economic Value (CEV) of a reward derived from social dissemination of a reward, which is calculated as Accumulative Economic Value (AEV)+Servitude Economic Value (SEV)+Redemption Economic Value (REV)−Actual Value of Reward (AV).

The objective of the invention is to create a social achievement and reward system (SARS), where an incentive system is linked to a social engagement reward value (SERV), which is the key measure or score of an individual's collaboration, teamwork, and social efforts and value. SERV is not simply tied to an action and financial reward; rather, SERV reflects how engaged a person is in both her real and virtual communities based on certain key factors such as, giving, performing online and offline activities, challenging other participants to engage in activities, communicating, promoting, motivating, participating, persevering, teaming up with others, taking on a cause, being asked to participate in activities, and other such social factors that give an individual a social worth or value from the perspective of both the other community members and those sponsors who have set up the activity or challenge. In addition, the invention provides merchants with a view of the Collective Economic Value (CEV) of the reward used, whether it be a product, service, merchandise, special offer, coupon, or deal that they offer, by assessing how the reward performs amongst a social community engaged in team play, collaborative work, and competition, where the CEV is a better reflection of a reward's actual value in a community rather than simply its apparent or stated monetary value, and a better determinant of which members of a group ascribe the highest value to that reward.

Embodiments of the present disclosure provide a method of valuing an individual or group of individual's social contributions. This involves an individual first joining or being selected to join a community. The community may be formed by a creator who selects the individuals to the community or by the coalescing of individuals about a collection of activities or challenges relating to a common interest or topic who found the community. The coalescing of individuals may result from individuals expressing a common interest as evidenced by common searches or search patterns. One or more of these individuals may then found the community. These activities or challenges are not required to be initiated by a single creator or individual. The creator or individual may also create a challenge or activity not associated with the specific community wherein the individual may also choose to join the different community associated with these other challenges and activities. The individuals participate in activities and as well as challenges of the community. In exchange for their participation and completion, the individual may receive rewards or points associated with the activities and challenges. The individual develops a score based on their social engagement. This score is a Social Engagement Reward Value (SERV) and represents their social engagement within the community. The rewards provided by the creator are awarded by the creator based on the individual's social engagement i.e. SERV and may come from a contributor. Additionally the community may be associated with a sponsor. The contributor, sponsor, and creator may select or retain individuals to the community or allow their rewards or their association with the community to be contingent upon an appropriate level of social engagement or minimum SERV value of the individuals or the aggregate SERV of the community.

The SERV value is based on the individual's level of participation, engagement, and completion of various social activities and/or challenges. In addition, rewards to challenges and activities participation may be further differentiated on completion as well as performance wherein an individual may only receive the reward if they have the overall best performance or if their performance exceeds a predetermined level as determined by the creator, sponsor, and/or contributor. In one example, the individual winning (placed highest within) the challenge may receive the most reward, while others who placed lower may receiver less reward. The community as a whole may receive a SERV score made by aggregating the SERV scores of the individuals within the community.

The rewards may have a collective economic value (CEV). This CEV may be based on the propagation of the reward between individuals within a community as well as charities or groups. Propagation may include how many times an actual award is transferred among individuals or communities. The CEV may also be based on the assignment of a reward to a charity, group, or individual as well as the redemption of the award. These values may be further enhanced or based upon the donation of the reward to a charity, group, or individual associated with both sides of the donation, the donee and the donor. Additionally the CEV may be in part based on the SERV of the individual redeeming the award or the SERV of the individuals to which the reward has been transferred to as it propagates from initial assignment by the creator until redemption.

The individuals and the reward may be further assigned a Brand Loyalty Value (BLV) wherein a measure is made of the number of times an individual returns for an activity or challenge based on the contributor of the reward. Thus individuals that return for rewards from specific contributors and rewards that promote the participation of individuals for rewards associated with this specific contributor may be measured to produce a measure of BLV.

The Social Achievement and Reward System (SARS) provided by embodiments of the present disclosure is a technology platform that enables individuals to earn rewards by maximizing their community involvement and participating in social activities, while also allowing businesses to promote their products or causes. The SARS technology platform may be implemented as computer program product comprising a non-transitory computer-readable storage medium containing computer program code that when executed by a processor causes the processor to allows a user to: create a social or community profile; participate in merchant or business communities that are promoting a product, business or cause; participate in another user's community to perform one or more activities or challenges; earn rewards or incentive points for participating in the communities, activities and challenges either created by merchants or other users; promote their own business or product by engaging other users to join their community and complete activities and challenges; create their own community, activities or challenges, then be able to advertise or promote the such communities, activities and challenges within the SARS system, or externally anywhere on the internet; create challenge ads, advertisements that are based on simple challenges to engage people into performing such challenges; compete in a community to complete activities or join a challenge to win the reward; promote a cause by engaging others to promote the same; participate in communities, activities or challenges as part of a team; earn a reward and donate the reward to others who have a greater need; accumulate points that can be converted to rewards; receive a social score, the Social Engagement Reward Value (SERV), for all social and community online and offline activities they get engaged in that makes the user gain a greater social value to other people and organizations; and receive higher end rewards or get invited for larger promotional activities by a business for having certain grades or tiers of SERV scores.

The SARS technology platform to allows a merchant to promote their product or business by rewarding social dissemination of their product or business by users, by: Establishment of rewards associated with joining the merchant's product or business community; Establishment of rewards associated with completing activities or challenges in order to promote the merchant's product or business to users; Promoting or advertising their reward to users of the system; Promoting or advertising their reward associated with a challenge or community with activities, by sponsoring the advertisement to engage other users; Transfer of rewards to a user upon completion of any activity or challenge created by the merchant; Transfer of special privileges, for example, special ambassador status or club access by merchant to a user, who most successfully promotes the merchant's products or business, as assessed by the user's SERV score; Assignment of merchant's special offers, coupons, or deals by a user to their own community, activity, or challenge, which in-turn, is earned by another user, thus disseminating a merchant's special offer, coupon, or deal for a product, and promoting the merchant's brand and business; Determination by merchant, the collective economic value (CEV) of a reward that is defined based on how many times a reward is redeemed, how many times a reward is transferred to keep the social engagement cycle continuing, and how many times the reward is donated to another person, therefore establishing a long-term value of each reward beyond the actual monetary value of a reward; Determination by a merchant, the brand loyalty value of a reward based on how many times a user repeatedly takes on an activity or challenge where a specific merchant or brand reward is available.

This technology platform also facilitates: the participation of an individual in special clubs or communities (based on the user's SERV score) by a merchant or any community sponsor; the distribution of exclusive offers, discounts, or coupons from merchants, where that user has achieved a higher status or privilege due to her SERV score, so the user may use these special offers, discounts, or coupons as rewards in their communities for driving even greater social engagement; the creation of specific criteria using the SERV score, to attract certain users to their special clubs or communities or establish rewards for the users who qualify for the merchant's specific criteria; the determination of a Collective Economic Value (CEV) of a reward that they offer in the system for use by users to engage others. The CEV is defined as Accumulative Economic Value (AEV) that is earned when users transfer rewards from themselves to others by engaging others to their communities, activities or challenges, plus (+) Servitude Economic Value (SEV), when users donate their earned rewards to others, plus (+) Redemption Economic Value (REV), when users actually earn the provided rewards in the system. The CEV is a measure of how a reward offer from a merchant performs long-term within a social achievement and reward system (SARS), connected to the social dissemination of that reward by users to engage with each other, collaborate, work in teams, and help each other; and the determination of a Brand Loyalty Value (BLV), defined as the number of times one particular user keeps returning for rewards offered for a specific brand provider or merchant.

The focus of this disclosure is on how a user increases their SERV score through her collaboration, teamwork, and social effort, to increase her social value to those individuals and organizations she interacts with. Examples of SERV score are provided below.

A simple example allows an individual person to complete a challenge. Then, their SERV increases. The individual earns 100 points. Two simple choices are 1) to use the points to purchase a reward for him or herself, or 2) donate the points to someone who has a greater need for them. SERV increases by a higher factor for earning the points, and for donating the points or rewards. SERV increases by a lower factor for keeping the points and rewards.

A more complex example allows an individual to complete a challenge. Then, their SERV increases. The individual earns 100 points. The person creates a new community in SARS for a cause such as “Breast Cancer Awareness”. The individual assigns the 100 points earned earlier, such that 10 people who join the community and perform an activity to raise awareness for this cancer, receive 10 points each for a total of 100 points. The person's SERV is even higher than it would have been for simply donating or keeping the points. The SERV is further raised, based for instance on the percentage of people who joined the community and performed the action, i.e. 100% engagement gets the Community Sponsor the highest SERV, 80% engagement generates a lower SERV, below 50% engagement yields an even lower SERV score.

The vision is that a social scoring system like the SERV can act as the equivalent of today's financial credit score, but it is not simply based on a person's individual achievement, but rather on their overall social community engagement, and is tied to receiving rewards for such engagement.

Another embodiment of the present disclosure provides as an award/reward or incentive that can be released as the individual completes various activities or challenges. For example a reward card such as a monetary card gift card having predetermined values stored within may allow the values or credits to be released as various activities or challenges are completed. One such example may be where a physician, social service, charity, insurance company or company health program may provide a stored value card or other like reward wherein the rewards are released as various milestones were met. These may be associated with weight loss and BMI, blood pressure or other behaviors that may improve one's health and life.

Those skilled in the art will recognize that modifications and variations can be made without departing from the spirit of the present disclosure. Therefore, we intend that embodiments of the present disclosure encompass all such variations and modifications as fall within the scope of the appended claims The system controllers or processors may comprise a microprocessor may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. Memory may couple to the microprocessor in the form of a single memory device or a plurality of memory devices. Such a memory device may be a read-only memory, random access memory, volatile memory, non-volatile memory, static memory, dynamic memory, flash memory, cache memory, and/or any device that stores digital information. Note that when the microprocessor implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory stores, and the processing module executes, operational instructions corresponding to at least some of the steps and/or functions illustrated in the FIGs.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

What is claimed is:

1. A method to value social contributions, the method comprising:
an individual joining a first community, the first community created by a first creator, wherein the first creator selects the individuals to the first community, wherein the individual participates in activities and/or challenges, wherein the activities and challenges are actual and/or virtual, and wherein rewards are associated with the activities and/or challenges;
scoring the individual's social engagement, wherein an assigned Social Engagement Reward Value (SERV) represents the individual's social engagement to the first community; and
rewarding the individual's social engagement by the first creator with the reward provided to the first creator by a first contributor.

2. The method of claim 1, wherein the first community is associated with a first sponsor.

3. The method of claim 1, wherein an individual's SERV is based on the individual's level of participation, engagement and completion of the activities and/or challenges.

4. The method of claim 1, wherein the first community comprises a set of individuals and wherein the first community receives a community SERV that comprises aggregated SERV of the set of individuals and the first creator.

5. The method of claim 1, wherein the first community participates in activities and/or challenges, wherein the first community is selected to participate in activities and/or challenges based on the SERV of the individuals and creator of the first community.

6. The method of claim 1, wherein a Collective Economic Value (CEV) is assigned to the reward, the CEV based on:
propagation of the reward;
assignment of the to a charity, group or individual; and/or
redemption of the reward.

7. The method of claim 1, wherein the individual joins at least one additional community, the at least one additional community created by the first creator and/or at least one additional creator, the at least one additional community associated with the first sponsor and/or at least one additional sponsor, and the rewards provided by the first contributor and/or at least one additional contributor.

8. The method of claim 1, wherein the first creator selects individuals to the first community based on the individual's SERV.

9. The method of claim 1, wherein the first sponsor selects the first community based on the SERV of the individuals and creator of the first community.

10. The method of claim 1, wherein the first contributor selects the reward provided to the first community based on the SERV of the individuals and creator of the first community.

11. The method of claim 1, wherein the social activities comprise performing any social action, the social action operable:
to help a person in need or a charitable organization;
to benefit another individual;
to build a team of individuals, the team operable to perform social activities;
to build communities with activities and challenges for other individuals to perform;
to build communities with activities and challenges for other individuals, wherein the individuals creating these communities, activities, and challenges, provides incentives;
to communicate with other individuals;
to moderate a community, activity or challenge;
to engage new individuals to join a community, activity, or challenge;
to determine negative scores, when individuals are not performing social actions;
to manage social voting and reviews within a community.

12. The method of claim 1, wherein the first sponsor uniquely scores individuals based on the individual's level of participation, engagement and completion of the activities and/or challenges.

13. A system operable to value and promote social contributions, the system comprising:
a network comprising a server operable:
to support a user interface;
to execute a first software engine operable to:
allow a first creator to create a first community and select individuals to the first community;
assign a Social Engagement Reward Value (SERV) to an individual's social engagement with the first community, the SERV represents the individual's level of participation, engagement and completion of the activities and/or challenges;
assign rewards from the first creator to the individual based on the individuals SERV, wherein the rewards are provided by a first contributor to the first creator, a first sponsor and a first contributor associated with the first community; and
to execute a second software engine operable to assign a Collective Economic Value (CEV) to the reward provided by the first creator to the individuals of the first community.

14. The system of claim 13, wherein the first community comprises a set of individuals and wherein the first community receives a community SERV that comprises aggregated SERV of the set of individuals and the creator.

15. The system of claim 13, wherein the first community participates in activities and/or challenges, wherein the first community is selected to participate in activities and/or challenges associated with the first contributor and/or first sponsor, the selection based on the SERV of the individuals and creator of the first community.

16. The system of claim 13, wherein the individual joins at least one additional community, the at least one additional community created by the first creator and/or at least one additional creator, the at least one additional community associated with the first sponsor and/or at least one additional sponsor, and the rewards provided by the first contributor and/or at least one additional contributor.

17. The system of claim 13, wherein a Collective Economic Value (CEV) is assigned to the reward, the CEV based on:
propagation of the reward;
assignment of the to a charity, group or individual; and/or
redemption of the reward.

18. The system of claim 13, wherein the first sponsor and or first contributor select the first community based on the SERV of the individuals and creator of the first community.

19. The system of claim 13, wherein the first sponsor and or first contributor uniquely scores individuals based on the individual's level of participation, engagement and completion of the activities and/or challenges.

20. The system of claim 13, wherein the social activities comprise performing any social action, the social action operable:
to help a person in need or a charitable organization;
to benefit another individual;
to build a team of individuals, the team operable to perform social activities;
to build communities with activities and challenges for other individuals to perform;
to build communities with activities and challenges for other individuals, wherein the individuals creating these communities, activities, and challenges, provides incentives;
to communicate with other individuals;
to moderate a community, activity or challenge;
to engage new individuals to join a community, activity, or challenge;
to determine negative scores, when individuals are not performing social actions;
to manage social voting and reviews within a community.

21. A method to value social contributions, the method comprising:
creating a first community, the first community created by a first creator, wherein the first community is associated with a first sponsor;
selecting an individual or set of individuals to join the first community, wherein the first creator selects the individuals to the first community, wherein the individual participates in activities and/or challenges, wherein the activities and challenges are actual and/or virtual, and wherein rewards are associated with the activities and/or challenges;
scoring the individual's social engagement, wherein an assigned Social Engagement Reward Value (SERV) represents the individual's social engagement to the first community, wherein the first community receives a community SERV that comprises aggregated SERV of the set of individuals and the first creator;
rewarding the individual's social engagement by the first creator, wherein a reward is provided by a first contributor; and
assigning a Collective Economic Value (CEV) to the reward, the CEV based on:
propagation of the reward;
assignment of the to a charity, group or individual; and/or
redemption of the reward.

22. The method of claim 21, wherein the first community participates in activities and/or challenges, wherein the first community is selected to participate in activities and/or challenges based on the SERV of the individuals and creator of the first community.

23. The method of claim 21, wherein the individual joins at least one additional community, the at least one additional community created by the first creator and/or at least one additional creator, the at least one additional community associated with the first sponsor and/or at least one additional sponsor, and the rewards provided by the first contributor and/or at least one additional contributor.

24. The method of claim 21, wherein the first creator selects individuals to the first community based on the individual's SERV.

25. The method of claim 21, wherein the first sponsor selects the first community based on the SERV of the individuals and creator of the first community.

26. The method of claim 21, wherein the first contributor selects the reward provided to the first community based on the SERV of the individuals and creator of the first community.

27. The method of claim 21, wherein the social activities comprise performing any social action, the social action operable:
to help a person in need or a charitable organization;
to benefit another individual;
to build a team of individuals, the team operable to perform social activities;
to build communities with activities and challenges for other individuals to perform;
to build communities with activities and challenges for other individuals, wherein the individuals creating these communities, activities, and challenges, provides incentives;
to communicate with other individuals;
to moderate a community, activity or challenge;
to engage new individuals to join a community, activity, or challenge;
to determine negative scores, when individuals are not performing social actions;
to manage social voting and reviews within a community.

28. The method of claim 21, wherein CEV is based on:
propagation of the reward and the SERV of the individuals receiving the reward;
assignment(s) of the reward to a charity, group or individual and the SERV of the charity, group or individual;
donation(s) of the reward to charity, group or individual and the SERV of the charity, group or individual; and/or
redemption of the reward and the SERV of the individual redeeming the reward.

29. The method of claim 21, further comprising assigning a Brand Loyalty Value (BLV), the BLV comprising a number of times one individual returns for rewards offered by the first contributor.

30. A computer program product comprising a non-transitory computer-readable storage medium containing computer program code that when executed by a processor causes the processor to:
receive first individual data comprising a first individual profile;
receive at least one additional individual data comprising at least one additional individual profile;
receive first creator inputs from a first creator, the first creator inputs associated with a first community, the first community associated with a first sponsor;
select at least one individual from a subset of the first individual and the at least one additional individual to the first community, wherein the individual participates in activities and/or challenges, wherein the activities and challenges are actual and/or virtual, and wherein rewards are associated with the activities and/or challenges;
score each selected at least one individual's social engagement, wherein an assigned Social Engagement Reward Value (SERV) represents the individual's social engagement to the first community;
reward each selected at least one individual's social engagement by the first creator; and
assign a Collective Economic Value (CEV) to a reward provided by a first contributor and assigned by the first creator to individual(s) of the first community.

31. The computer program of claim 30, wherein the first community receives a community SERV that comprises aggregated SERVs of each selected at least one individual.

32. The computer program of claim 30, wherein the individuals SERV is based on the individual's level of participation, engagement and completion of the activities and/or challenges.

33. The computer program of claim 30, wherein the individual selects to at least one additional community, the at least one additional community created by the first creator and/or at least one additional creator, the at least one additional community associated with the first sponsor and/or at least one additional sponsor, and the rewards provided by the first contributor and/or at least one additional contributor.

34. The computer program of claim 30, wherein an each selected at least one individual's SERV comprises rewards for the each selected at least one individual's level of participation and engagement with social activities.

35. The computer program of claim 30, wherein the social activities comprise performing any social action, the social action operable:
to help a person in need or a charitable organization;
to benefit another individual;
to build a team of individuals, the team operable to perform social activities;
to build communities with activities and challenges for other individuals to perform;
to build communities with activities and challenges for other individuals, wherein the individuals creating these communities, activities, and challenges, provides incentives;
to communicate with other individuals;
to moderate a community, activity or challenge;
to engage new individuals to join a community, activity, or challenge;
to determine negative scores, when individuals are not performing social actions;
to manage social voting and reviews within a community.

36. The computer program of claim 30, wherein CEV is determined by:
propagation of the reward and the SERV of the individuals receiving the reward;
assignment(s) of the reward to a charity, group or individual and the SERV of the charity, group or individual;
donation(s) of the reward to charity, group or individual and the SERV of the charity, group or individual; and/or
redemption of the reward and the SERV of the individual redeeming the reward.

37. The computer program of claim 30, further comprising:
assigning a Brand Loyalty Value (BLV), the BLV comprising a number of times an individual returns for rewards offered by the first contributor.
